(19) United States
(12) Patent Application Publication
(10) Pub. No.: US 2004/0210707 A1
(43) Pub. Date: Oct. 21, 2004

(54) Storage device and apparatus for and method of writing data

(75) Inventors: Minoru Ohara, Tokyo (JP); Hiroshi Iwasaki, Suita-shi (JP); Fumio Kurokawa, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/760,456

(22) Filed: Jan. 21, 2004

(30) Foreign Application Priority Data
Jan. 21, 2003 (JP) P2003-012765
Nov. 12, 2003 (JP) P2003-383060

(51) Int. Cl. G06F 12/00

(52) U.S. Cl. 711/103; 711/163

(57) ABSTRACT

A storage device including a storage medium having a data area configured to write content data therein and an identifier area configured to write an identifier therein, and a storage medium support frame configured to hold the storage medium and provided with visible information that corresponds to the identifier, the visible information being visible from the outside and selected from the group consisting of a character, symbol, pattern, color, and combination of a character, symbol, pattern, and color.

### CROSS REFERENCE TO RELATED APPLICATIONS

This application is based upon and claims the benefit of priorities from prior Japanese Patent Applications P2003-12765 filed on Jan. 21, 2003 and P2003-383060 filed on Nov. 12, 2003; the entire contents of which are incorporated be reference herein.

### BACKGROUND OF THE INVENTION

1. Field of the Invention

The present invention relates to a storage device having a storage element and an apparatus for and a method of writing data and the like in the storage device.

2. Description of Related Art

Recently, storage devices or storage media such as MDs, CD-Rs, CD-RWs, DVD-RAMs, DVD-RWs, and small memory cards and apparatuses to write electronic data in such storage devices or media have been developed on a large scale in multimedia businesses. Various memory cards have been proposed, and some of them have decorative pictorial patterns printed on the surfaces of their frames (for example, Japanese Patent Laid Open Publication (Kokai) No. 2001-84347).

During the large-scale development of storage device businesses, storage devices have been standardized to improve versatility thereof and compatibility of writing apparatuses for them. The standardization has also promoted competition among storage device manufacturers, greatly reduced the prices of storage devices, and thinned the profits of the manufacturers.

The versatility of the storage devices, however, must not be narrowed because it decreases a market scale of storage devices, drops the amount of products, and increases the manufacturing costs of storage devices.

Storage devices such as memory cards are in need of a technique for disabling content data stored therein once the content data has been illegally copied or altered. An example of such a technique provides a memory card with an individual ID (identification information) serving as an encryption key and encrypting content data stored in the memory card with the ID (for example, Japanese Patent Laid Open Publication (Kokai) No. 2000-112824).

According to this technique, content data encrypted with individual IDs and stored in individual memory cards differs from memory card to memory card. A file size of content data is usually very large, occupying the most part of the storage capacity of a memory card, and therefore, encrypted content data that differs from memory card to memory card complicates an operation of writing the encrypted content data in the memory cards and elongates a time of the writing operation.

### SUMMARY OF THE INVENTION

According to an aspect of the present invention, a storage device includes

a storage medium having a data area configured to write content data thereto and an identifier area configured to write an identifier thereto, and a storage medium support frame configured to hold the storage medium and provided with visible information that corresponds to the identifier, the visible information being visible from the outside and selected from the group consisting of a character, symbol, pattern, color, and combination of a character, symbol, pattern, and color.

According to another aspect of the present invention, a writing apparatus includes a storage unit configured to store an identifier, a software file name, a title of the software, and a visible information file that are related to one another, a display controller configured to read the visible information file and the title from the storage unit and output a display signal to display visible information and the title, a display configured to receive the display signal from the display controller and display the visible information and the title, a slot configured to receive a storage device therein, an identifier reader configured to read an identifier stored in the storage device inserted in the slot, an identifier-corresponding-software searcher configured to determine if software corresponding to the identifier read by the identifier reader is stored in the storage unit, and a writer configured to write the software corresponding to the identifier to the storage device, when the software corresponding to the identifier is present.

According to an another aspect of the present invention, a replay program enabling a computer to execute instructions includes instructions configured to read a first identifier from an identifier area of a storage medium, instructions configured to read a second identifier from a data area of the storage medium, instructions configured to conduct at least one operation of decrypting the second identifier, confirming if the second identifier is a first electronic watermark embedded therein, and decrypting the second identifier and confirming if the second identifier is the first electronic watermark embedded therein, instructions configured to compare the first identifier and the second identifier with each other, when a case selected from the group consisting of the second identifier being decrypted, the second identifier being confirmed as being the first electronic watermark embedded therein, and the second identifier being decrypted and being confirmed as being the first electronic watermark embedded therein is satisfied, instructions configured to read content data from the data area, instructions configured to conduct an operation selected from decrypting the content data, confirming if the content data is a second electronic watermark embedded therein, and decrypting the content data and confirming if the content data is the second watermark embedded therein when at least a predetermined part of the first and second identifiers are identical to each other; and instructions configured to replay the content data when a case selected from the group consisting of the content data being confirmed as being the second electronic watermark embedded therein, the content data being decrypted, and the content data being decrypted and being confirmed as being the second electronic watermark embedded therein is satisfied.

According to another aspect of the present invention, a computer readable storage medium includes an identifier area configured to store a first identifier, and a data area configured to store a second identifier, content data and a replay program, the second identifier having at least one characteristic in which the second identifier is encrypted, the second identifier is a first electronic watermark embedded therein, and the second identifier is the first electronic watermark embedded therein and is encrypted, the content data having at least one characteristic in which the content data is encrypted, the content data is a second electronic watermark embedded therein, and the content data is the second electronic watermark embedded therein and is encrypted, and the replay program configured to make a computer execute instructions including instructions configured to read the first identifier from the identifier area, instructions configured to read the second identifier from the data area, instructions configured to conduct an operation selected from the group consisting of decrypting the second identifier, confirming if the second identifier is the first electronic watermark embedded therein, and decrypting the second identifier and confirming if the second identifier is the first electronic watermark embedded therein, instructions configured to compare the first identifier and the second identifier with each other when a case selected from the group consisting of the second identifier being decrypted, the second identifier being confirmed as being the first electronic watermark embedded therein, and the second identifier being decrypted and being confirmed as being the first electronic watermark embedded therein is satisfied, instructions configured to read the content data from the data area, instructions configured to conduct an operation selected from decrypting the content data, confirming if the content data is the second electronic watermark embedded therein, and decrypting the content data and confirming if the content data is the second watermark embedded therein when at least a predetermined part of the first and second identifiers are identical to each other, and instructions configured to replay the content data when a case selected from the group consisting of the content data being decrypted, the content data being confirmed as being the second electronic watermark embedded therein, and the content data being decrypted and being confirmed as being the second electronic watermark embedded therein is satisfied.

According to an another aspect of the present invention, a writing method includes writing a second identifier in a data area, the second identifier being obtained by at least one operation in which a first identifier written in an identifier area is encrypted, a first electronic watermark is embedded in the first identifier, and the first electronic watermark in the first identifier is embedded and is encrypted, writing content data to the data area, the content data having at least one characteristic in which the content data is encrypted, the content data is a second electronic watermark embedded therein, and the content data is the second electronic watermark embedded therein and is encrypted, and writing a replay program to the data area, the replay program being configured to make a computer execute instructions including, instructions configured to read the first identifier from the identifier area, instructions configured to read the second identifier from the data area, instructions configured to conduct an operation selected from the group consisting of decrypting the second identifier, confirming if the second identifier is the first electronic watermark embedded therein, and decrypting the second identifier and confirming if the second identifier is the first electronic watermark embedded therein, instructions configured to compare the first identifier and the second identifier with each other when a case selected from the group consisting of the second identifier being decrypted, the second identifier being confirmed as being the first electronic watermark embedded therein, and the second identifier being decrypted and being confirmed as being the first electronic watermark embedded therein is satisfied, instructions configured to read the content data from the data area, instructions configured to conduct an operation selected from decrypting the content data, confirming if the content data is the second electronic watermark embedded therein, and decrypting the content data and confirming if the content data is the second watermark embedded therein, when at least a predetermined part of the first and second identifiers are identical to each other, and instructions configured to replay the content data when a case selected from the group consisting of the content data being decrypted, the content data being confirmed as being the second electronic watermark embedded therein, and the content data being decrypted and being confirmed as being the second electronic watermark embedded therein is satisfied.

According to another aspect of the present invention, a writing apparatus includes a slot configured to receive a storage device therein, an identifier reader configured to read a first identifier from an identifier area of the storage device inserted in the slot, an identifier processor configured to obtain a second identifier by conducting at least one operation in which a first electronic watermark is embedded in the first identifier, the first identifier is encrypted, and the first identifier being the first electronic watermark embedded therein is encrypted, a storage unit configured to store content data and a reply program, the content data having a characteristic selected from the group consisting of embedding a second electronic watermark therein, being encrypted, and embedding the second electronic watermark therein and being encrypted, and the replay program configured to make a computer execute instructions including instructions configured to read the first identifier from the identifier area, instructions configured to read the second identifier from a data area of the storage device, instructions configured to conduct an operation selected from the group consisting of decrypting the second identifier, confirming if the second identifier is the first electronic watermark embedded therein, and decrypting the second identifier and confirming if the second identifier is the first electronic watermark embedded therein, instructions configured to compare the first identifier and the second identifier with each other when a case selected from the group consisting of the second identifier being decrypted, the second identifier being confirmed as being the first electronic watermark embedded therein, and the second identifier being decrypted and being confirmed as being the first electronic embedded watermark embedded therein is satisfied, instructions configured to read the content data from the data area, instructions configured to conduct an operation selected from decrypting the content data, confirming if the content data is the second electronic watermark embedded therein, and decrypting the content data and confirming if the content data is the second watermark embedded therein when at leas a predetermined part of the first and second identifiers are identical to each other; and instructions configured to replay the content data when a case selected from the group consisting of the content data being decrypted, the content data being confirmed as being the second electronic watermark embedded therein, and the content data being decrypted and being confirmed as being the second electronic watermark embedded therein is satisfied, and a writer configured to write the second identifier, content data, and replay program to the data area of the storage device.

### BRIEF DESCRIPTION OF THE DRAWINGS

FIGS. 1A and 1B show a configuration of a card-type storage device according to an embodiment 1 of the present invention, in which FIG. 1A is a perspective view and FIG. 1B a sectional view taken along a line A-A′ of FIG. 1A;

FIG. 2 shows a configuration of a first face of a storage device module shown in FIGS. 1A and 1B;

FIG. 3 shows a configuration of physical blocks in the storage device module;

FIGS. 4A and 4B show relationships between identifiers stored in storage device modules and pictorial patterns printed on the surfaces of support frames, in which FIG. 4A shows that an identifier “ABC” corresponds to a pictorial pattern “Star” and FIG. 4B shows that an identifier “DEF” corresponds to a pictorial pattern “Moon”;

FIG. 5 is a functional block diagram schematically showing a software writing apparatus according to the embodiment 1 of the present invention;

FIG. 6 is a flowchart showing a flow of a writing process;

FIGS. 7A and 7B show relationships among pictorial patterns printed on card-type storage devices, pictorial patterns displayed on a display of the writing apparatus, and writing results according to the embodiment 1, in which FIG. 7A shows that a printed pictorial pattern agrees with a displayed pictorial pattern and FIG. 7B shows that a printed pictorial pattern disagrees with a displayed pictorial pattern;

FIG. 8 is a functional block diagram schematically showing a software writing apparatus according to an embodiment 2 of the present invention;

FIGS. 9A and 9B show relationships among pictorial patterns printed on card-type storage devices, pictorial patterns displayed on a display of the writing apparatus, and writing results according to the embodiment 2, in which FIGS. 9A and 9B each shows that a printed pictorial pattern agrees with a displayed pictorial pattern;

FIG. 10 is a flowchart showing a process of replaying content data written in a memory card according to an embodiment 3 of the present invention;

FIGS. 11A to 11E show the embodiment 3, in which FIG. 11A shows an identifier in an identifier area, an identifier in a data area, a replay program in the data area, and content data in the data area in a memory card MC1, FIG. 11B shows an identifier in an identifier area, an identifier in a data area, a replay program in the data area, and content data in the data area in a memory card MC2, FIG. 11C shows the identifier, replay program, and content data copied from the data area of the memory card MC1 to the data area of the memory card MC2, FIG. 11D shows the replay program and content data copied from the data area of the memory card MC1 to the data area of the memory card MC2, and FIG. 11E shows the content data copied from the data area of the memory card MC1 to the data area of the memory card MC2;

FIG. 12 is a block diagram showing a writing apparatus according to an embodiment 4 of the present invention;

FIG. 13 is a flowchart showing a writing process according to the embodiment 4;

FIG. 14 is a block diagram showing a writing apparatus according to an embodiment 5 of the present invention;

FIG. 15 is a flowchart showing a writing process according to the embodiment 5;

FIG. 16 is a block diagram showing a writing apparatus according to an embodiment 6 of the present invention;

FIG. 17 is a flowchart showing a writing process according to the embodiment 6; and

FIGS. 18A to 18C show the embodiment 6 of the present invention, in which FIG. 18A shows three memory cards MC601 to MC603 and card IDs thereof, FIG. 18B shows that a replay program and content data written in a data area of the memory card MC601 are identical to those written in a data area of the memory card MC602, and FIG. 18C shows that an encrypted identifier written in the data area of the memory card MC601 differs from that written in the data area of the memory card MC602.

### DETAILED DESCRIPTION OF EMBODIMENTS

Embodiments according to the present invention will be explained with reference to the accompanying drawings. The present invention, however, is not limited to these embodiments. In the drawings, same or like parts are represented with same or like reference numerals.

### Embodiment 1

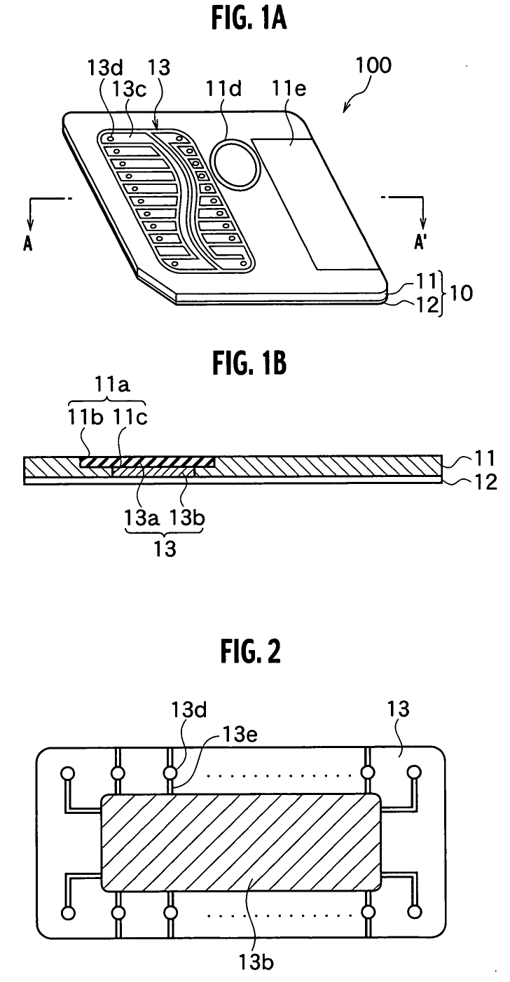

FIGS. 1A and 1B show a configuration of a card-type storage device according to the embodiment 1 of the present invention, in which FIG. 1A is a perspective view and FIG. 1B is a sectional view taken along a line A-A′ of FIG. 1A. FIG. 2 shows a first face of a storage device module shown in FIGS. 1A and 1B.

The card-type storage device 100 is small and thin and consists of a storage device module 13 of about 0.665 mm thick and a holder 10 of about 0.76±0.08 mm thick to hold the module 13.

The holder 10 consists of a support frame 11 made of resin and having an opening 11a and a support sheet 12 attached to the whole bottom face of the support frame 11. The opening 11a of the support frame 11 includes a recess 11b and a through hole 11c that is formed at the bottom of the recess 11b and is smaller than the recess 11b. The support frame 11 also has a write protect area 11d to prohibit writing and a seal attaching area 11e.

The storage device module 13 includes a wiring board 13a having a first face and a second face. On the first face of the wiring board 13a, there is mounted a semiconductor storage device 13b sealed with resin. Connection terminals of the semiconductor storage device 13b are connected to wiring 13e and through holes 13d and then to flat external connection terminals 13c arranged on the second face of the wiring board 13a.

The storage device module 13 is fitted and adhered to the opening 11a of the holder 10 so that the flat external connection terminals 13c are exposed. Namely, as shown in FIG. 1B, the wiring board 13a is fitted in the recess 11b of the opening 11a, and the flat external connection terminals 13c are flush with and exposed from the surface of the holder 10. At this time, the semiconductor storage device 13b is fitted in the through hole 11c and is bonded thereto. The semiconductor storage device 13b is, for example, a flash memory or a mask ROM.

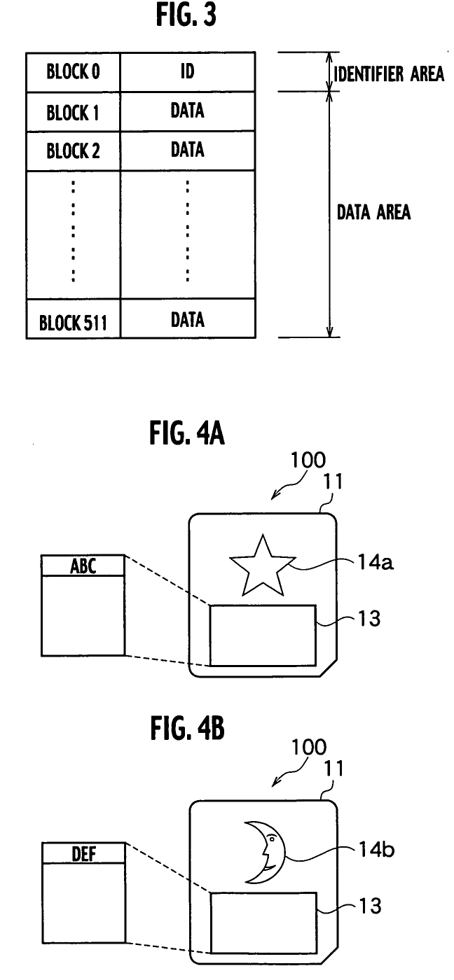

FIG. 3 shows a configuration of physical blocks in the storage device module 13. An identifier (ID) area is defined. The identifier area is an area to store an identifier that corresponds to a pictorial pattern printed on the surface of the support frame 11.

FIGS. 4A and 4B show relationships between identifiers stored in storage device modules and pictorial patterns printed on the surfaces of support frames 11. In FIG. 4A, an identifier “ABC” corresponds to a pictorial pattern 14a of “Star,” and in FIG. 4B, an identifier “DEF” corresponds to a pictorial pattern 14b of “Moon.”

It is preferable that a short side of the support frame 11 is longer than 31.8 mm. With a short side longer than 31.8 mm, the card-type storage device 100 is considered unable to be accidentally ingested by a child younger than 18-month old, as specified in the Toy Safety Reference Book issued by the Japan Toy Safety Association.

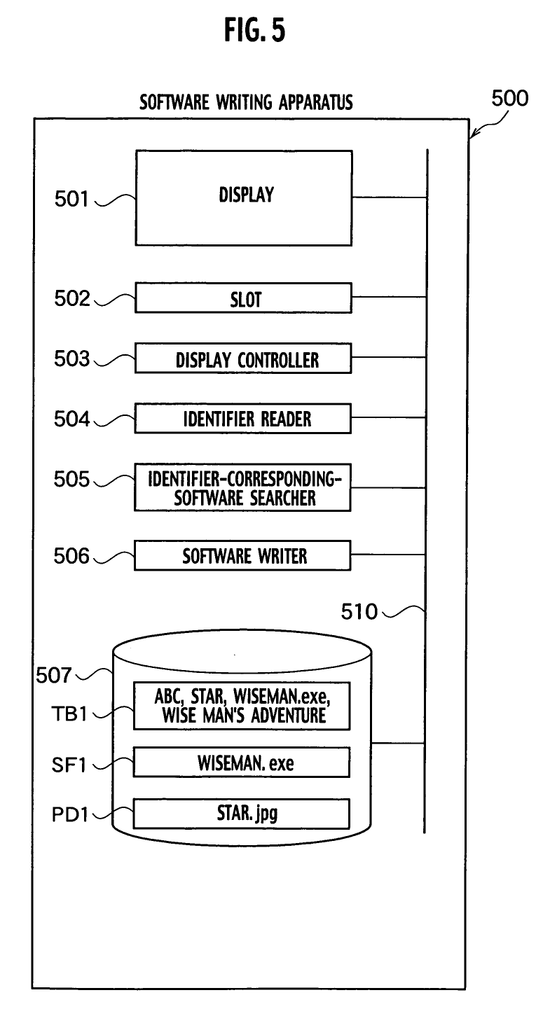

FIG. 5 is a functional block diagram schematically showing a configuration of a software writing apparatus according to the embodiment 1 of the present invention. In FIG. 5, the software writing apparatus 500 has a display 501, a slot 502, a display controller 503, an identifier reader 504, an identifier-corresponding-software searcher 505, a software writer 506, a storage unit 507, and a bus 510 that connects these components to one another.

The slot 502 receives the card-type storage device 100 shown in FIG. 1.

The identifier reader 504 reads an identifier stored in the card-type storage device 100 inserted in the slot 502.

The identifier-corresponding-software searcher 505 checks to see if software corresponding to the identifier read by the identifier reader 504 is stored in the storage unit 507.

The storage unit 507 stores a correspondence table TB1 showing a relationship among an identifier, a pictorial pattern name, a software file name, and a software title. The storage unit 507 also stores software SF1 and pictorial pattern data PD1 corresponding to the identifier. The identifier may be an alphabetical identifier such as ABC or DEF or any other identifier composed of Hiragana, Katakana, Kanji, other characters, numerals, or a combination thereof. The pictorial pattern name is a word such as Star or Moon. The pictorial pattern name is a part of or a whole of a visible information file name. The visible information file includes a pictorial pattern data file. The pictorial pattern data file includes the JPEG format file, the GIF format file and the BMP format file. The software file name is a unique file name and may be a combination of alphanumeric characters. The software title is a software commodity name or sales name, for example, “Wise Man's Adventure.” The correspondence table TB1 includes at least a record composed of, for example, an identifier field, a pictorial pattern name field, a file name field, and a title field. These fields contain a concrete identifier, a pictorial pattern name, a file name, and a title, respectively. The identifier, pictorial pattern name, file name, and title stored in each record are related to one another.

The display controller 503 reads a pictorial pattern name (for example, “Star”) and software title (for example, “Wise Man's Adventure”) stored in a given record in the correspondence table of the storage unit 507 and displays, on the display 501, the title and a pictorial pattern read from a pictorial pattern data file (for example, “Star.jpg”) specified by the pictorial pattern name.

The software writer 506 writes software in the card-type storage device 100.

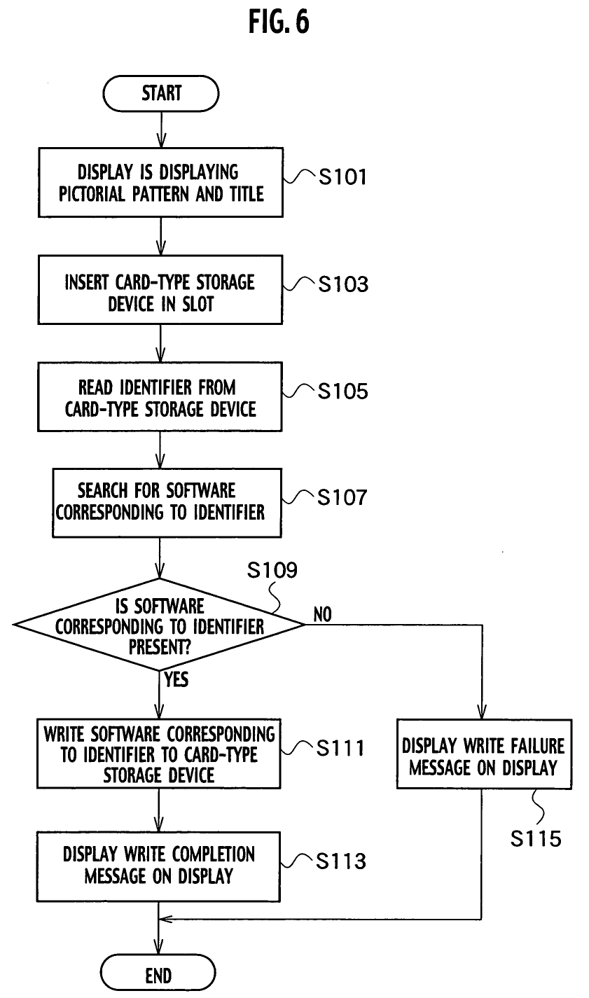

With reference to FIG. 6, a flow of a writing process will be explained. First, the display controller 503 reads the correspondence table TB1 from the storage unit 507, reads a pictorial pattern name “Star” and software title “Wise Man's Adventure” from a given record, and displays, on the display 501, a pictorial pattern “Star” read from pictorial pattern data “Star.jpg” PD1 and the title “Wise Man's Adventure” (step S101).

When the cart-type storage device 100 is inserted into the slot 502 (step S103), the identifier reader 504 reads an identifier stored in the card-type storage device 100 (step S105).

The identifier reader 504 sends the read identifier to the identifier-corresponding-software searcher 505. The searcher 505 checks the correspondence table TB1 stored in the storage unit 507 to see if there is software corresponding to the read identifier (step S107).

If the read identifier is related to software in the correspondence table TB1 (YES in step S109), the software writer 506 writes the software corresponding to the read identifier into the card-type storage device 100 inserted in the slot 502 (step S111).

When the writing of the card-type storage device 100 is completed, the display controller 503 displays a write completion message on the display 501 (step S113).

If the read identifier corresponds to no software in the correspondence table TB1 (NO in step S109), the display controller 503 displays a write failure message on the display 501 (step S115).

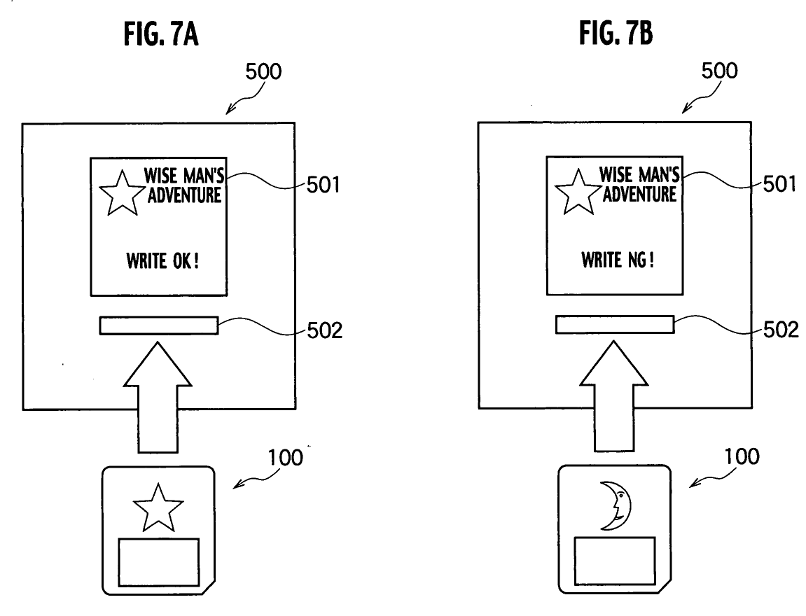

FIGS. 7A and 7B show relationships among pictorial patterns printed on card-type storage devices 100, pictorial patterns displayed on the display 501, and write results displayed on the display 501. In FIG. 7A, the printed pictorial pattern agrees with the displayed pictorial pattern. In FIG. 7B, the printed pictorial pattern disagrees with the displayed pictorial pattern.

In FIG. 7A, the card-type storage device 100 having a pictorial pattern “Star” printed on the support frame 11 is inserted into the slot 502 of the software writing apparatus 500 with the display 501 displaying the pictorial pattern “Star.” The reading of an identifier, the searching of corresponding software, and the writing of the corresponding software (having a file name “wiseman.exe”) are conducted, and the display 501 displays a message of “Write OK!.”

In FIG. 7B, the card-type storage device 100 having a pictorial pattern “Moon” printed on the support frame 11 is inserted into the slot 502 of the software writing apparatus 500 with the display 501 displaying a pictorial pattern “Star.” The reading of an identifier, the searching of corresponding software, and the determination of nonexistence of corresponding software are conducted, and the display 501 displays a message of “Write NG!.”

According to the embodiment 1, the card-type storage device 100 has, for example, an identifier “ABC” and a pictorial pattern “Star” that corresponds to the identifier “ABC” and is printed on the support frame 11. When this card-type storage device 100 is inserted into the software writing apparatus 500 displaying a pictorial pattern “Star,” software having a file name “wiseman.exe” is written to the card-type storage device 100.

The card-type storage device 100 may have an identifier “DEF” and a pictorial pattern “Moon” that corresponds to the identifier “DEF” and is printed on the support frame 11. When this card-type storage device 100 is inserted into the software writing apparatus 500 displaying the pictorial pattern “Star,” the software “wiseman.exe” is not written to the card-type storage device 100.

Namely, the software is written only to a card-type storage device printed with the pictorial pattern “Star” and is never written to a card-type storage device printed with the pictorial pattern “Moon.”

The software writing apparatus 500 distinguishes a card-type storage device 100 authorized to write software therein from an unauthorized card-type storage device 100 according to identifiers. At the same time, a user can quickly, surely, and easily determine whether or not a card-type storage device 100 is an authorized one by seeing a pictorial pattern printed thereon.

### Embodiment 2

According to the embodiment 1, the card-type storage device 100 printed with “Star” is authorized to write software, and the card-type storage device 100 printed with “Moon” is unauthorized to write the software. A software writing apparatus according to the embodiment 2 enables the card-type storage device 100 printed with “Star” as well as the card-type storage device 100 printed with “Moon” to be written with software by changing a setting without regard to what was set before the setting change.

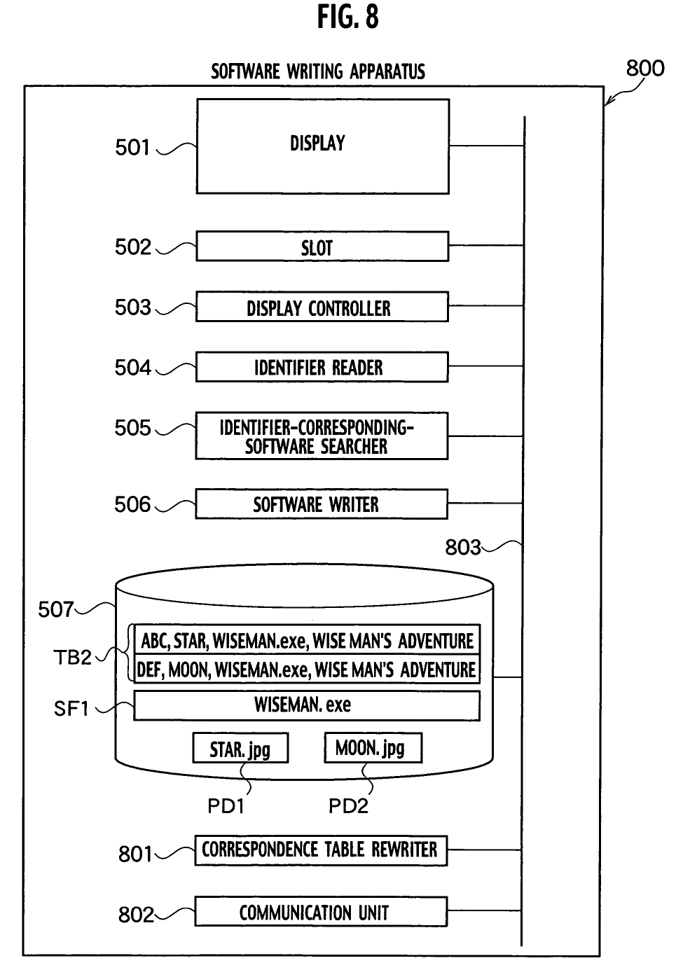

FIG. 8 is a functional block diagram schematically showing a configuration of the software writing apparatus 800 according to the embodiment 2. In FIG. 8, the software writing apparatus 800 has a display 501, a slot 502, a display controller 503, an identifier reader 504, an identifier-corresponding-software searcher 505, a software writer 506, a storage unit 507, a correspondence table rewriter 801, a communication unit 802, and a bus 803 connecting these components to one another. Except for the contents of the storage unit 507, the correspondence table rewriter 801, and the communication unit 802, the components of the embodiment 2 are substantially the same as those of the embodiment 1, and therefore, the same components will not be explained.

The communication unit 802 receives data from the outside of the software writing apparatus 800 through a wireless or wire communication circuit (not shown).

The correspondence table rewriter 801 rewrites an identifier-software correspondence table TB2 stored in the storage unit 507 according to the data received through the communication unit 802. Here, “rewrite” means not only overwriting old data with new data but also adding new data to old data without deleting the old data. For example, the correspondence table rewriter 801 rewrites the correspondence table TB2 to the storage unit 507 as follows:

“ABC, Star, wiseman.exe, Wise Man's Adventure”

“DEF, Moon, wiseman.exe, Wise Man's Adventure”

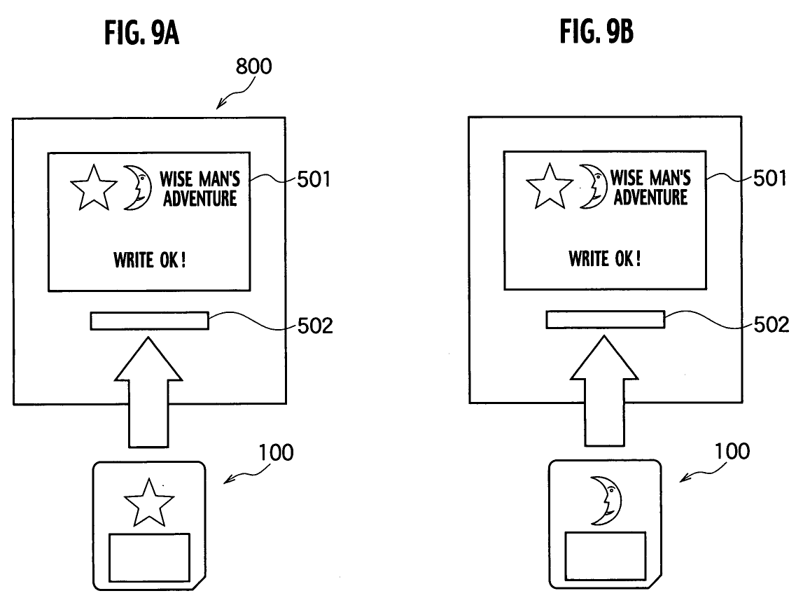

As shown in FIGS. 9A and 9B, with the identifier-software correspondence table TB2 rewritten as mentioned above, the display 501 of the software writing apparatus 800 displays pictorial patterns “Star” and “Moon” and a title “Wise Man's Adventure.”

In FIG. 9A, a card-type storage device 100 having a pictorial pattern “Star” on the support frame 11 is inserted into the slot 502 of the software writing apparatus 800 displaying the pictorial patterns “Moon” and “Star” on the display 501. Then, the reading of an identifier, the searching of corresponding software, and the writing of the corresponding software (having a file name “wiseman.exe”) are conducted, and the display 501 displays a message of “Write OK!.”

Similarly, in FIG. 9B, a card-type storage device 100 having a pictorial pattern “Moon” on the support frame 11 is inserted into the slot 502 of the software writing apparatus 800 displaying the pictorial patterns “Moon” and “Star” on the display 501. Then, the reading of an identifier, the searching of corresponding software, and the writing of the corresponding software (having the file name “wiseman.exe”) are conducted, and the display 501 displays a message of “Write OK!.”

The embodiment 2 provides the same effect as the embodiment 1. In addition, the embodiment 2 can write the software (having the file name “wiseman.exe”) into the card-type storage device 100 having the identifier “ABC” and the corresponding pictorial pattern “Star” printed on the support frame 11 as well as into the card-type storage device 100 having the identifier “DEF” and the corresponding pictorial pattern “Moon” printed on the support frame 11.

Before rewriting, the correspondence table TB2 in the storage unit 507 is set to write software to the card-type storage device 100 printed with the pictorial pattern “Star” and not to write the software to the card-type storage device 100 printed with the pictorial pattern “Moon.” After the rewriting, the correspondence table TB2 allows the software to be written to the card-type storage device 100 printed with the pictorial pattern “Star” as well as to the card-type storage device 100 printed with the pictorial pattern “Moon.”

For example, the card-type storage device 100 printed with the pictorial pattern “Star” may be an exclusive storage device for game software marketed by a company A, and the card-type storage device 100 printed with the pictorial pattern “Moon” may be an exclusive storage device for game software marketed by a company B. If the companies A and B tie up their businesses, the embodiment 2 allows any card-type storage device 100 printed with one of the pictorial patterns “Star” and “Moon” to download the game software marketed by the company A.

In this way, any one of the embodiments 1 and 2 is capable of using first visible information (such as a pictorial pattern) that may be printed on a first storage device (such as a card-type storage device) and second visible information (such as a pictorial pattern) that may be printed on a second storage device (such as a card-type storage device), to determine whether or not a first identifier stored in the first storage device is identical to a second identifier stored in the second storage device.

In addition, any one of the embodiments 1 and 2 is capable of using first visible information that may be printed on a storage device and second visible information that is displayed on a display of a software writing apparatus, to easily, quickly, and surely determine, before inserting the storage device into the software writing apparatus, whether or not the storage device is allowed to write software thereto with the software writing apparatus.

Further, any one of the embodiments 1 and 2 is capable of providing, without a manufacturing cost increase, a storage device whose versatility is freely controllable and a software writing apparatus that can write software to such a storage device.

### Embodiment 3

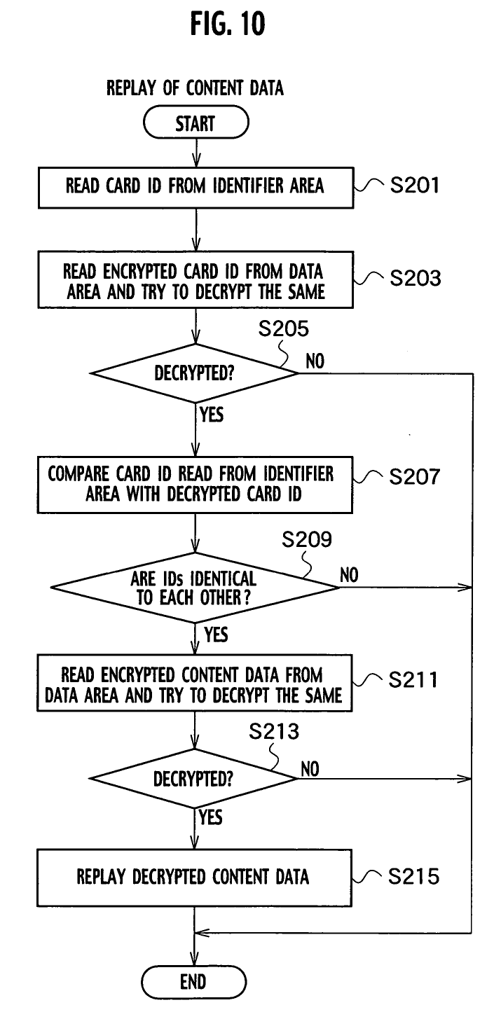

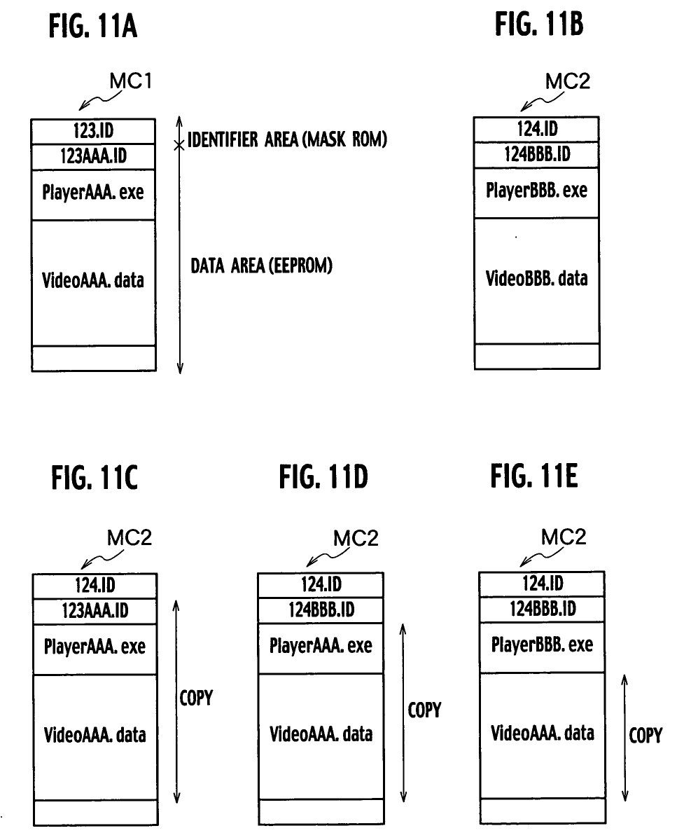

With reference to FIGS. 10 and 11, data and a program to be written to a memory card (card-type storage device) will be explained.

FIG. 10 shows a flow of replaying content data written to a memory card, and FIGS. 11A to 11E show an identifier area and a data area in a memory card and identifiers, a content replay program, and content data written in the areas.

(Data and Other Information Written in Memory Card)

In FIGS. 11A to 11E, a memory card includes an identifier (card ID) area and a data area. The identifier area is made of, for example, a mask ROM, and the data area is made of, for example, a NAND-type flash EEPROM. The identifier area stores a card ID of, for example, 128 bits specific to the memory card. The data area stores, for example, the following files:

a) VideoAAA.data

b) 123AAA.ID

c) PlayerAAA.exe

a) VideoAAA.data is video data for a video program having a name “AAA.” This video data is compressed according to, for example, MPEG2 and is encrypted according to, for example, RSA. The compression method may be MPEG1, MPEG4, and the like instead of MPEG2. The encryption method may be DSA and the like instead of RSA.

b) 123AAA.ID is a card ID “123” encrypted according to, for example, RSA. Like VideoAAA.data, any other encryption method may be employed instead of RSA.

c) PlayerAAA.exe is a program to replay VideoAAA.data and is capable of:

c1) reading 123.ID from the identifier area;

c2) reading the encrypted 123AAA.ID from the data area and decrypting the same;

c3) comparing 123.ID read from the identifier area with the card ID read from the data area and decrypted and determining whether or not they agree with each other;

c4) reading the encrypted VideoAAA.data from the data area and decrypting the same; and

c5) playing the decrypted video data.

PlayerAAA.exe has a decryption key used to decrypt 123AAA.ID and a decryption key used to decrypt VideoAAA.data. These keys may be the same as or different from each other.

Using a common decryption key helps reduce the file size of PlayerAAA.exe. If VideoAAA.data is compressed according to, for example, MPEG2, PlayerAAA.exe must have a function of decompressing the compressed data.

(Replay Process of Content Data)

With reference to FIGS. 10 and 11, a flow of a replay process of content data “VideoAAA.data” by the content data replay program “PlayerAAA.exe” will be explained.

In step S201, the replay program reads 123.ID (first storage medium ID) from the identifier area of the memory card.

In step S203, the replay program reads the encrypted identifier 123AAA.ID (second storage medium ID) from the data area of the memory card and tries to decrypt the same.

In step S207, the replay program compares the card ID obtained by the decryption of step S203 with the card ID read from the identifier area and provides a comparison result. The comparison result indicates whether the card IDs are identical to each other.

In step S211, the card IDs are identical to each other, and the replay program reads the content data “VideoAAA.data” from the data area and tries to decrypt the same.

In step S215, the replay program plays the content data obtained by the decryption of step S211.

If the card ID is unable to decrypt in step S203, or if the card IDs are not identical to each other in step S207, or if the content data is unable to decrypt in step S211, the process is terminated.

In this way, the embodiment 3 is capable of preventing an illegal use of content data. This will be explained in detail in the following section.

(Prevention of Illegal Use)

With reference to FIGS. 11A to 11E, prevention of an illegal use of content data will be explained. The prevention of illegal use according to the embodiment 3 is not intended to prevent the copying of data files. It intends to prevent the replay of copied content data.

A memory card MC1 shown in FIG. 11A stores 123.ID in an identifier area, and in a data area, 123AAA.ID, PlayerAAA.exe, and VideoAAA.data. 123AAA.ID and VideoAAA.data are encrypted and are decrypted with the use of PlayerAAA.exe.

A memory card MC2 shown in FIG. 11B stores 124.ID in an identifier area, and in a data area, 124BBB.ID, PlayerBBB.exe, and VideoBBB.data. 124BBB.ID and VideoBBB.data are encrypted and are decrypted with the use of PlayerBBB.exe.

PlayerAAA.exe is unable to decrypt 124BBB.ID or VideoBBB.data. PlayerBBB.exe is unable to decrypt 123AAA.ID or VideoAAA.data.

(If All Files are Illegally Copied)

First, the prevention of use of illegally copied files when all files are illegally copied will be explained.

FIG. 11C shows that all files have been copied from the memory card MC1 to the memory card MC2.

Under this state, PlayerAAA.exe is instructed to replay VideoAAA.data. First, PlayerAAA.exe reads 124.ID from the identifier area of the memory card MC2 (S201 of FIG. 10). Then, PlayerAAA.exe reads the encrypted 123AAA.ID from the data area of the memory card MC2 and tries to decrypt the same (S203). PlayerAAA.exe can decrypt 123AAA.ID, and therefore, step S205 branches to YES. However, 124.ID read from the identifier area is not equal to the decrypted 123.ID, and therefore, step S209 branches to NO to terminate the process. In this way, the illegally copied content data is prevented from being replayed.

(If Some Files are Illegally Copied)

Next, the prevention of use of illegally copied files when some files are illegally copied will be explained.

FIG. 11D shows that PlayerAAA.exe and VideoAAA.data have been copied from the memory card MC1 to the memory card MC2.

Under this state, PlayerAAA.exe is instructed to replay VideoAAA.data. First, PlayerAAA.exe reads 124.ID from the identifier area of the memory card MC2 (S201 of FIG. 10). Then, PlayerAAA.exe reads the encrypted 124BBB.ID from the data area of the memory card MC2 and tries to decrypt the same (S203). PlayerAAA.exe is unable to decrypt 124BBB.ID, and therefore step S205 branches to NO to terminate the process. In this way, replay of the illegally copied content data is prevented.

FIG. 11E shows that only VideoAAA.data has been copied from the memory card MC1 to the memory card MC2.

Under this state, PlayerBBB.exe is instructed to replay VideoAAA.data. First, PlayerBBB.exe reads 124.ID from the identifier area of the memory card MC2 (S201 of FIG. 10). Then, PlayerBBB.exe reads 124BBB.ID from the data area of the memory card MC2 and tries to decrypt the same (S203). PlayerBBB.exe can decrypt 124BBB.ID, and therefore, step S205 branches to YES. 124.ID read from the identifier area is identical to the decrypted 124.ID, and therefore, step S209 branches to YES. However, PlayerBBB.exe is unable to decrypt VideoAAA.data, and therefore, step S213 branches to NO to terminate the process. In this way, the illegally copied content data is prevented from being replayed.

In this way, the embodiment 3 can prevent the replay of content data when part or all of the “encrypted card ID data,” “encrypted content data,” and “program capable of decrypting encrypted data” have been illegally copied.

The replay process flow shown in FIG. 10 is only an example. For example, it is possible to read a card ID from an identifier area only after a card ID read from a data area has been successfully decrypted. Namely, step S201 shown in FIG. 10 may be moved between steps S205 and S207.

### Embodiment 4

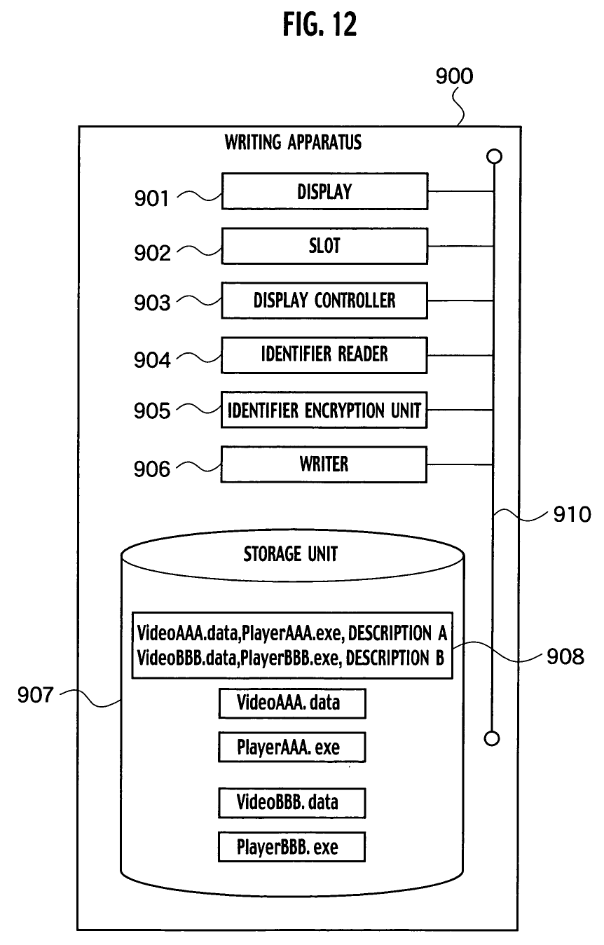

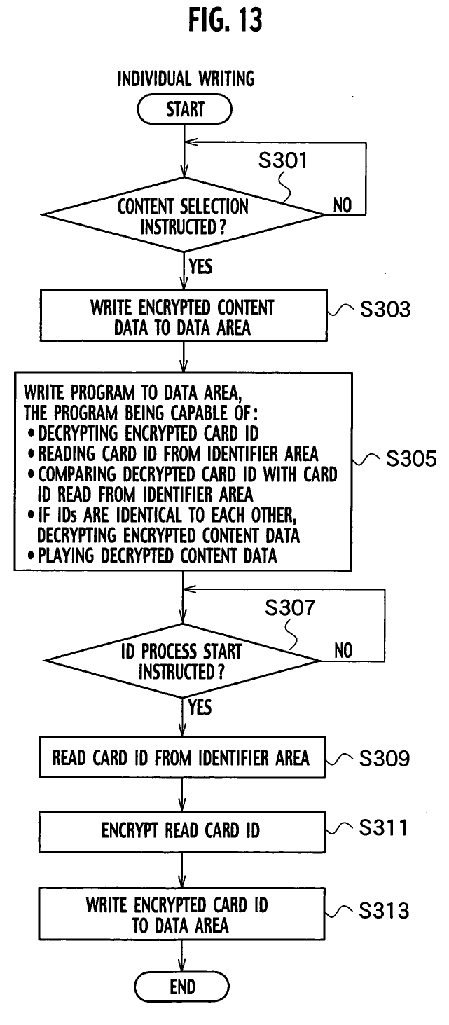

With reference to FIGS. 12 and 13, a writing apparatus installed in, for example, a convenience store and used to write content data, etc., in a memory card will be explained.

In FIG. 12, a writing apparatus 900 is installed in, for example, a shop. The writing apparatus 900 has a display 901, a slot 902, a display controller 903, an identifier reader 904, an identifier encryption unit 905, a writer 906, a storage unit 907, and a bus 910 that connects these components to each other.

The slot 902 receives a card-type storage device (memory card) 100 shown in FIG. 1. The display 901 displays, for example, a description relating to content to be written in the memory card.

The identifier reader 904 reads an identifier (card ID) from an identifier area of the memory card inserted in the slot 902. The identifier encryption unit 905 encrypts the identifier. The writer 906 writes the encrypted identifier in the memory card.

The storage unit 907 stores encrypted content data VideoAAA.data and VideoBBB.data, replay programs PlayerAAA.exe and PlayerBBB.exe, and a correspondence table 908. The correspondence table 908 stores relationships among the content data, the replay programs, text data (for example, descriptions A and B) for explaining the content data, and the like.

The display controller 903 displays, for example, the description A in the correspondence table 908 on the display 901. A user reads the description displayed on the display 901 and selects a content to be purchased.

In FIG. 13, a content selection instruction is input in step S301. In step S303, the writer 906 writes encrypted content data in a data area of the memory card inserted in the slot 902. If the display 901 has a touch panel function, inputting the content selection instruction may include a user touching a button on the touch panel corresponding to the content to be purchased. If a button corresponding to VideoAAA.data is touched, the writer 906 reads VideoAAA.data from the storage unit 907 and writes the same in the data area of the memory card inserted in the slot 902.

In step S305, a replay program is written to the memory card. Like the embodiment 3, the replay program is capable of (a) reading an encrypted card ID from the data area of the memory card and decrypting the same, (b) reading a card ID from the identifier area of the memory card, (c) comparing the decrypted card ID with the card ID read from the identifier area, (d) if the card IDs agree with each other, reading encrypted content data from the data area and decrypting the same, and (e) playing the decrypted content data.

Step S307 waits for an instruction to start an ID process. The ID process is a series of processes to write an encrypted card ID in the data area of the memory card. Starting the ID process is instructed, for example, when proper payment for the content data is confirmed.

In step S309, the identifier reader 904 reads the card ID from the identifier area of the memory card in the slot 902. In step S311, the identifier encryption unit 905 encrypts the read card ID. In step S313, the writer 906 writes the encrypted card ID in the data area of the memory card.

Generally, the user enters a content selection instruction (step S301), and a content price is displayed on the display 901. Then, the user takes out a purse, takes out notes or coins therefrom, and inserts the money into a slot. Once a correct amount of money has been inserted, the start of the ID process is instructed (step S307). Accordingly, inputting a content select instruction (step S301) to determining the start of the ID process (S307) usually takes a time period of about 15 to 30 seconds.

On the other hand, content data (for example, VideoAAA.data) which may be, for example, an animation of 24 minutes in playing time has a file size of about 30 megabytes (MB) in MPEG2. A program (for example, PlayerAAA.exe) to decrypt and play the content data has a file size of about 1 MB. Therefore, the data and program may need about five seconds to write them to a memory card.

Namely, the writing of content data and replay program will finish while a user takes out a purse and takes out money therefrom, and therefore, the user will not be kept waiting.

The card ID data (such as 123AAA.ID) has a file size of only several bytes to several tens of bytes, and therefore, reading the card ID, encrypting the same, and writing the encrypted card ID need only about one second. This never keeps the user waiting.

On the other hand, a conventional writing method selects content, reads a card ID from a memory card, and uses the card ID to encrypt content data of 30 MB or over. This takes about 50 seconds. Accordingly, in a time period while a user takes out a purse and takes out money therefrom, the writing of the content data and a replay program will not be completed and will keep the user waiting.

According to the embodiment 4, a time necessary for copying content data and other data is shortened to an extent that produces no waiting time for a user.

The above-mentioned time for writing content data and other data in a memory card assumes a standard personal computer with a clock rate of 2 GHz and a memory capacity of about 256 MB and a relatively high-speed memory card writer connected to the personal computer through a USB2.0 interface.

### Embodiment 5

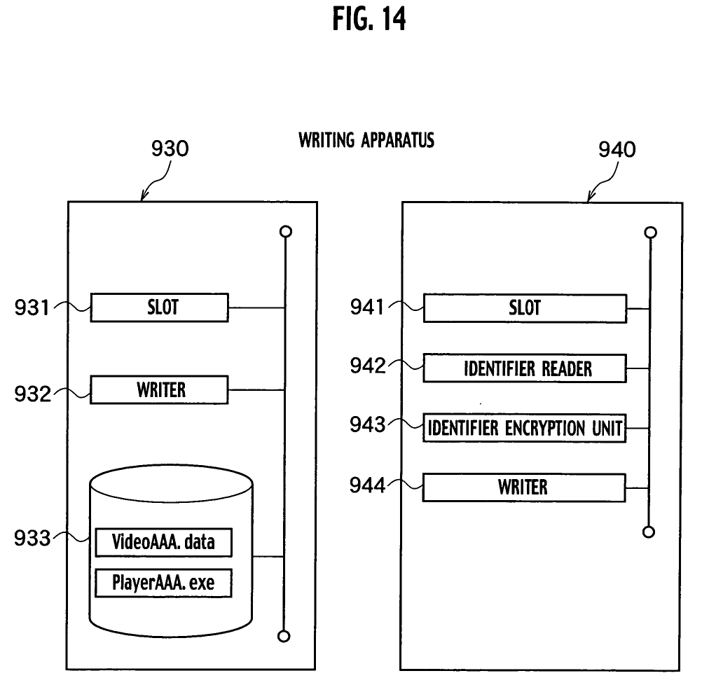

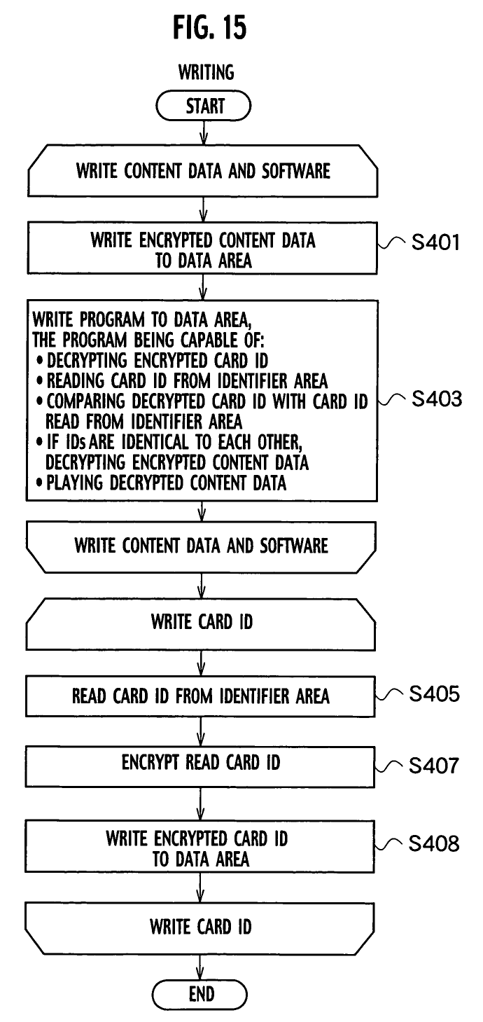

With reference to FIGS. 14 and 15, a writing method to mass-produce memory cards with content data and the like written therein will be explained.

FIG. 14 shows a first writing apparatus 930 and a second writing apparatus 940 according to the embodiment 5.

The first writing apparatus 930 has a slot 931 to receive a memory card, a writer 932 to write content data and a replay program in a data area of the memory card, and a storage unit 933 to store content data (such as VideoAAA.data) and a replay program (such as PlayerAAA.exe).

The second writing apparatus 940 has a slot 941 to receive a memory card, an identifier reader 942 to read an identifier from an identifier area of the memory card, an identifier encryption unit 943 to encrypt the read identifier, and a writer 944 to write the encrypted identifier in a data area of the memory card.

FIG. 15 shows a flow of a write process according to the embodiment 5. First, the first writing apparatus 930 is employed to write common content data and a common replay program to each of a plurality of memory cards (steps S401 and S403). Then, the second writing apparatus 940 is employed to write an encrypted identifier specific to each memory card of the memory cards.

In step S401, the writer 932 writes VideoAAA.data stored in the storage unit 933 in the data area of the memory card inserted in the slot 931.

In step S403, the writer 932 writes PlayerAAA.exe in the data area of the memory card. Like the embodiment 3, the PlayerAAA.exe is a program capable of carrying out the following operations in response to a content replaying instruction:

(a) reading the encrypted card ID (identifier) from the data area of the memory card and decrypting the same;

(b) reading the card ID from the identifier area of the memory card;

(c) comparing the decrypted card ID with the card ID read from the identifier area;

if the card IDs agree with each other,

(d) reading the encrypted content data from the data area and decrypting the same; and

(e) playing the decrypted content data.

Steps S401 and S403 are repeated a given number of times, and step S405 is carried out. In step S405, the identifier reader 942 reads a card ID from the identifier area of the memory card inserted in the slot 941.

In step S407, the identifier encryption unit 943 encrypts the read card ID. In step S408, the writer 944 writes the encrypted card ID in the data area of the memory card.

In this way, the writing method according to the embodiment 5 writes common content data and replay program to each of a plurality of memory cards.

On the other hand, there is a conventional method that assigns a different card ID to each memory card and employs the card ID to encrypt content data. This method involves the following steps:

(a) reading a first card ID from a first memory card, employing the first card ID to encrypt content data, and writing the encrypted content data to the first memory card;

(b) reading a second card ID from a second memory card, employing the second card ID to encrypt the content data, and writing the encrypted content data to the second memory card;

(c) reading a third card ID from a third memory card, employing the third card ID to encrypt the content data, and writing the encrypted content data to the third memory card; and so on.

According to this method, writing encrypted content data in, for example, 1000 memory cards needs 1000 times of repetition of encrypting the content data with card IDs.

On the other hand, according to the writing method of the embodiment 5, content data to be written is common for all memory cards, and therefore, writing content data in, for example, 1000 memory cards requires only one time of the content data encrypting process.

The embodiment 5 must repeat the encrypting of a card ID in the number of memory cards. While content data has a size of several tens of megabytes or over, a card ID involves only several bytes to several tens of bytes. Accordingly, a time necessary for encrypting a card ID is much shorter than that for encrypting content data.

Consequently, compared with the conventional writing method, the writing method of the embodiment 5 can speedily mass-produce memory cards written with common content data and other data.

### Embodiment 6

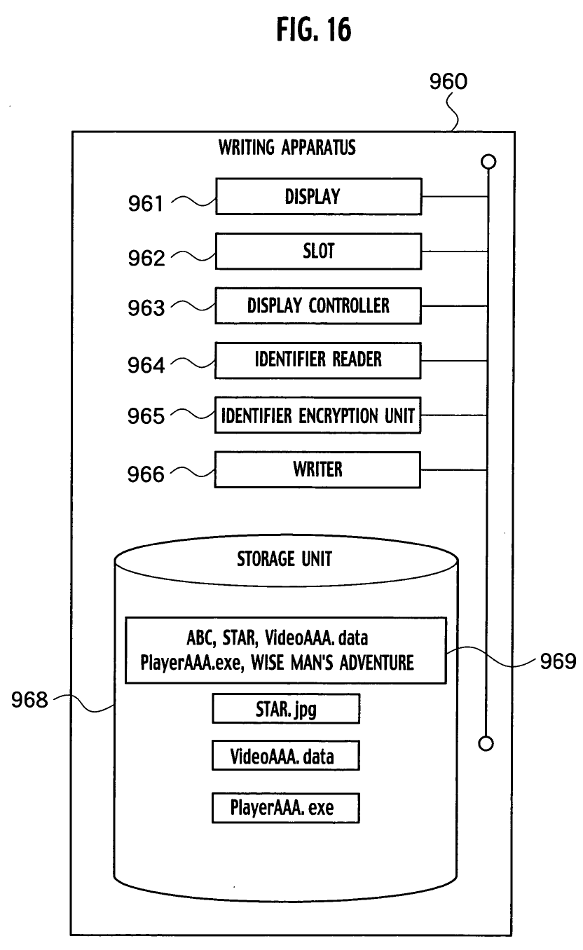

FIG. 16 shows a writing apparatus 960 according to the embodiment 6. In FIG. 16, the writing apparatus 960 has a display 961, a slot 962, a display controller 963, an identifier reader 964, an identifier encryption unit 965, a writer 966, and a storage unit 968.

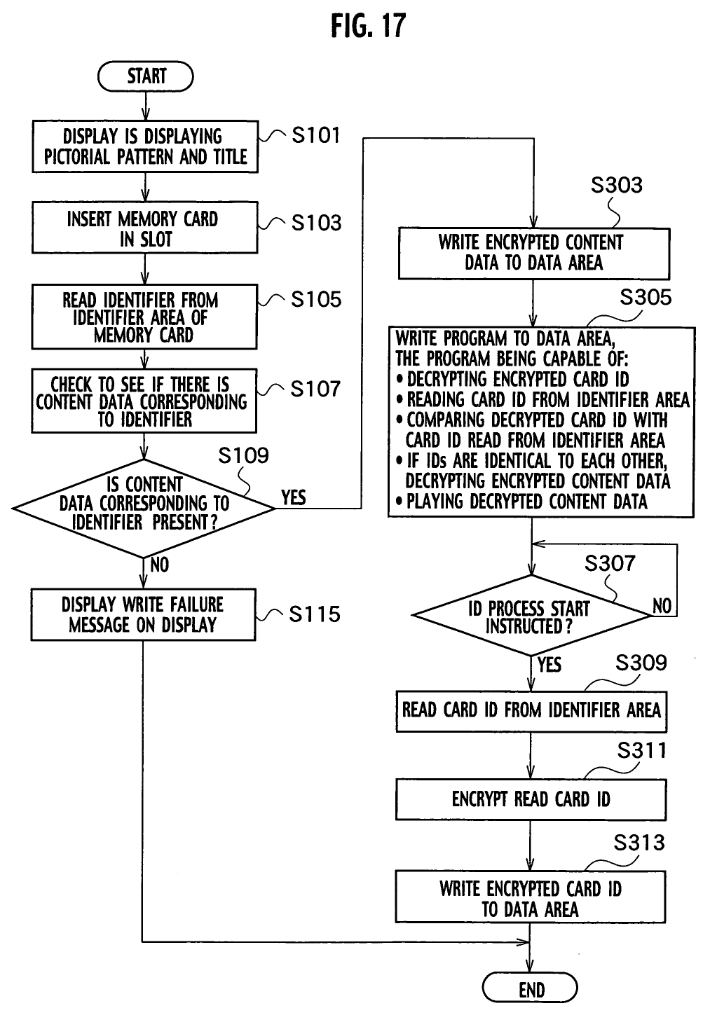

FIG. 17 shows a flow of a write process according to the embodiment 6. In step S101, the display 961 shows a picture of a star and a title “Wise Man's Adventure” as shown in FIG. 7A. This is done by, for example, the display controller 963 that reads a correspondence table 969 indicating a relationship of “ABC, Star, VideoAAA.data, PlayerAAA.exe, Wise Man's Adventure” from the storage unit 968 and displays a text “Wise Man's Adventure” found in the correspondence table 969 on the display 961. Further, the display controller 963 reads Starjpg corresponding to “Star” from the storage unit 968 and displays a pictorial pattern of “Star” on the display 961.

In step S103, a memory card is inserted into the slot 962. In step S105, the identifier reader 964 reads an identifier from an identifier area of the memory card. In step S107, it is checked to see if content data corresponding to the read identifier is stored in the storage unit 968. If there is the content data corresponding to the identifier, step S109 branches to “YES” and proceeds to step S303.

If there is no content data corresponding to the identifier, step S109 branches to “NO” to terminate the process.

Determining whether or not there is content data corresponding to the identifier is conducted according to the correspondence table 969 and a part of the identifier. If the identifier consists of, for example, 128 bits, the determination is made according to, for example, 28 bits among the 128 bits.

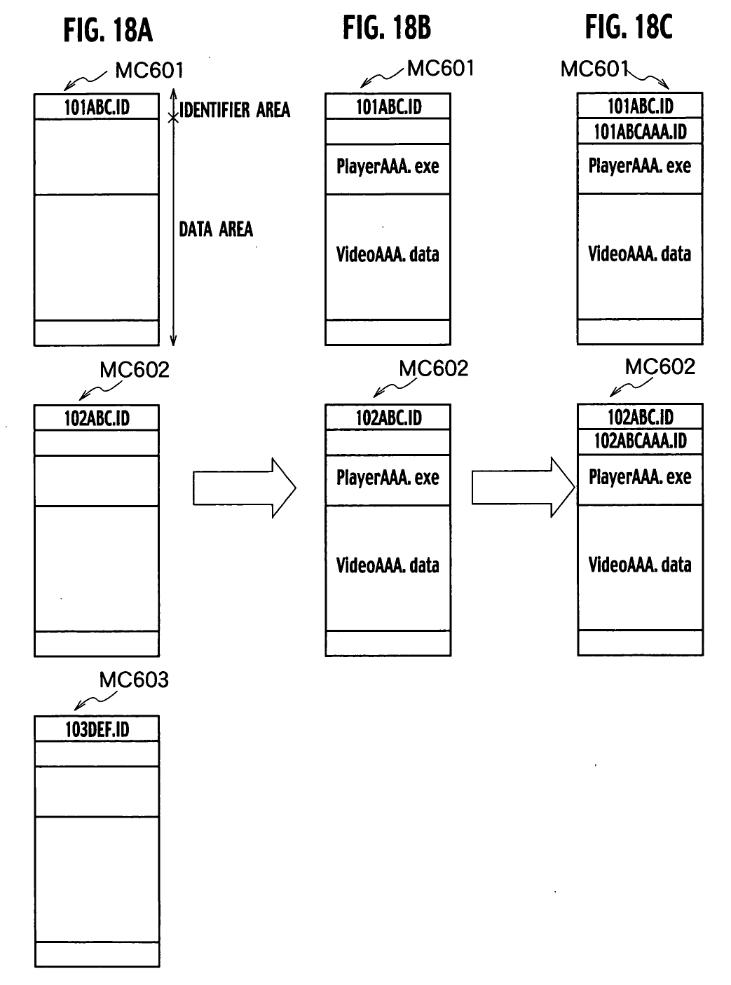

A determination of the presence of content data to be made according to lower three characters of an identifier will be explained. FIG. 18A shows three memory cards MC601 to MC603 having card IDs 101ABC, 102ABC, and 103DEF, respectively. The memory cards MC601 and MC602 have each lower three characters of ABC and the correspondence table 969 contains “ABC, . . . ,” and therefore, it is determined that there is content data corresponding to the identifiers of the memory cards MC601 and MC602. On the other hand, the memory card MC603 has the lower three characters “DEF” and the correspondence table 969 contains no corresponding identifier data, and therefore, it is determined that there is no content data corresponding to the identifier of the memory card MC603.

In step S303, the writer 966 writes encrypted content data in a data area of the memory card. For example, according to the relationship “ABC, . . . , VideoAAA.data, . . . ,” in the correspondence table 969, it is determined to write “VideoAAA.data” to each memory card having the lower three identifier characters “ABC,” and VideoAAA.data is written in the data area of each of the memory cards MC601 and MC602.

In step S305, the writer 966 writes a replay program in the data area of the memory card. For example, according to the relationship “ABC, . . . , PlayerAAA.exe, . . . ” in the correspondence table 969, it is determined to write “PlayerAAA.exe” to each memory card having the lower three identifier characters “ABC,” and PlayerAAA.exe is written in the data area of each of the memory cards MC601 and MC602.

In FIG. 18B, PlayerAAA.exe and VideoAAA.data are written in the data area of each of the memory cards MC601 and MC602.

Step S307 is the same as step S307 of the embodiment 4, and therefore, an explanation thereof is omitted. In step S309, the identifier reader 964 reads a card ID from an identifier area of the memory card. In step S311, the identifier encryption unit 965 encrypts the read card ID. In step S313, the writer 966 writes the encrypted card ID in the data area of the memory card.

As a result of a series of the processes, FIG. 18C shows that PlayerAAA.exe and VideoAAA.data stored in the storage unit 968 have been copied to the data area of each of the memory cards MC601 and MC602, and the identifier read from the identifier area of each of the memory cards and encrypted has been written in the data area of each of the memory cards.

In FIG. 18C, the content data and replay program written in the data area of each of the memory cards MC601 and MC602 are identical between the memory cards MC601 and MC602. On the other hand, the encrypted identifiers written in the data areas of the memory cards MC601 and MC602 differ from each other.

In this way, according to the embodiment 6, a user who intends to write content data to a memory card using the writing apparatus 960 can visually compare a pictorial pattern displayed on the display 961 of the writing apparatus 960 with a pictorial pattern printed on a support frame of the memory card. Then, the user can easily determine whether or not the memory card is allowed to write data therein, or which memory card is allowed to write data therein with the writing apparatus 960 in front of the user.

The content data and content data replay program to be written by the writing apparatus 960 are already encrypted and stored in the storage unit 968. Namely, they are not encrypted after the insertion of a memory card into the writing apparatus 960, and therefore, a time period from the insertion of a memory card into the slot 962 to the start of data writing is short, and a time to complete the writing is also short.

A card ID as a whole may be encrypted, or a part of the card ID may be encrypted if the part is unique (has no resemblance to other card IDs). If a card ID consists of, for example, 128 bits, and if 28 bits among them are used to classify content and the remaining 100 bits are specific to the card, the whole 128 bits of the card ID may be encrypted, or the 100 bits that are specific to the card may be encrypted.

According to the embodiments 3 to 6, an encrypted card ID and encrypted content data are written in a data area of a memory card. If a replay program can decrypt the card ID and content data and if a card ID in an identifier area of the memory card is identical to the decrypted card ID, the replay of the content is allowed. Conditions to allow the replay may exclude the successful decryption.

An electronic watermark, for example, may be used as a replay allowing condition. More precisely, a card ID is read from an identifier area of a memory card, an electronic watermark is embedded in the read card ID, and the electronic-watermark-embedded card ID is written in a data area of the memory card. At the same time, electronic-watermark-embedded content data is written in the data area.

In this case, a replay program (a) reads the embedded electronic watermark from the card ID in the data area of the memory card in response to a replay instruction, (b) after confirming that the card ID in the data area has a correct embedded electronic watermark, compares the card ID in the identifier area with the card ID in the data area, (c) if the IDs are identical to each other, reads the electronic watermark embedded in the content data, and (d) after confirming that the content data has a correct embedded electronic watermark, starts to replay the content data.

Before confirming that the card ID read from the data area has a correct embedded electronic water mark, it is possible to read the card ID from the identifier area. It is also possible to read the card ID from the identifier area after confirming that the card ID read from the data area has a correct embedded electronic watermark.

The card ID read from the identifier area and the card ID read from the data area may not completely be equal to each other. If a unique part of the card ID read from the identifier area is identical to a unique part of the card ID read from the data area are identical to each other, the replay of the content data may be allowed.

The decryption and electronic watermark may be combined together to provide a replay allowing condition. For example, a card ID stored in a data area of a memory card is encrypted, and the decrypting thereof is tried. If it is successfully decrypted, the decrypted card ID is compared with a card ID stored in an identifier area of the memory card.

If the IDs are completely identical to each other as a result of the comparison, or if they are partly equal to each other to satisfy a given condition, an electronic watermark is read from electronic-watermark-embedded content data. If a correct electronic watermark is read, the replay of the content data is allowed.

Instead, if the IDs are completely identical to each other, or if they are partly equal to each other to satisfy a given condition, the decrypting of encrypted content data is tried. If it is successfully decrypted, an electronic watermark is read therefrom. If a correct electronic watermark is read out of the decrypted content data, and the replay of the content data is allowed.

According to the embodiments 3 to 6, a replay program to start the replay of content data stored in a storage device is obtainable only after (a) confirming, through decryption and/or an electronic watermark, that a second identifier is proper for the replay program, (b) confirming that the second identifier is proper for a first identifier, and (c) confirming, through decryption and/or an electronic watermark, that the content data is proper for the replay program. Copying all or part of the second identifier, content data, and replay program from the storage device to another storage device is incapable of replaying the content data, thereby effectively preventing an illegal use of the content data.

According to the embodiment 4, the replay program and content data explained in the embodiment 3 are written to a storage medium in a short time that creates no sense of waiting for a user.

According to the embodiment 5, storage media in each of which the replay program and content data explained in the embodiment 3 are written can be produced in a short time compared with the method that repeats encryption on every storage medium.

Although the invention has been described above by reference to certain embodiments of the invention, the invention is not limited to the embodiments described above. Modifications and variations of the embodiments described above will occur to those skilled in the art, in the light of the above teachings. The scope of the invention is defined with reference to the following claims.

What is claimed is:

1. A storage device comprising:
a storage medium having a data area configured to write content data thereto and an identifier area configured to write an identifier thereto; and
a storage medium support frame configured to hold the storage medium and provided with visible information that corresponds to the identifier, the visible information being visible from the outside and selected from the group consisting of a character, symbol, pattern, color, and combination of a character, symbol, pattern, and color.

2. The storage medium of claim 1, wherein:
the storage medium support frame has a substantially rectangular shape and a short side of at least 31.8 mm.

3. The storage medium of claim 1, wherein:
the identifier is readable by a writing apparatus; and
the writing apparatus displays, on a display thereof, information selected from the group consisting of a character, symbol, pattern, color, and combination of a character, symbol, pattern, and color, and when the visible information agrees with the displayed information, conducts writing.

4. A writing apparatus comprising:
a storage unit configured to store an identifier, a software file name, a title of the software, and a visible information file that are related to one another;
a display controller configured to read the visible information file and the title from the storage unit and output a display signal to display visible information and the title;
a display configured to receive the display signal from the display controller and display the visible information and the title;
a slot configured to receive a storage device therein;
an identifier reader configured to read an identifier stored in the storage device inserted in the slot;
an identifier-corresponding-software searcher configured to determine if software corresponding to the identifier read by the identifier reader is stored in the storage unit; and
a writer configured to write the software corresponding to the identifier to the storage device, when the software corresponding to the identifier is present.

5. The writing apparatus of claim 4, wherein the storage device comprises:
a storage medium having a data area configured to write content data thereto and an identifier area configured to write an identifier thereto; and
a storage medium support frame configured to hold the storage medium and provided with visible information that corresponds to the identifier, the visible information being visible from the outside and selected from the group consisting of a character, symbol, pattern, color, and combination of a character, symbol, pattern, and color.

6. The writing apparatus of claim 5, wherein:
the storage medium support frame has a substantially rectangular shape and a short side of at least 31.8 mm.

7. The writing apparatus of claim 4, wherein:
the writer conducts the writing when the visible information on the storage medium agrees with the visible information displayed on the display, the visible information on the display being selected from the group consisting of a character, symbol, pattern, color, and combination of a character, symbol, pattern, and color.

8. The writing apparatus of claim 4, further comprising:
a correspondence table rewriter configured to rewrite a correspondence table showing correspondence among the identifier, file name, title, and visible information file.

9. The writing apparatus of claim 5, further comprising:
a communication unit configured to receive data required to rewrite the correspondence table from outside of the writing apparatus.

10. A replay program enabling a computer to execute instructions comprising:
instructions configured to read a first identifier from an identifier area of a storage medium;
instructions configured to read a second identifier from a data area of the storage medium;
instructions configured to conduct an operation selected from the group consisting of decrypting the second identifier, confirming if the second identifier is a first electronic watermark embedded therein, and decrypting the second identifier and confirming if the second identifier is the first electronic watermark embedded therein;
instructions configured to compare the first identifier and the second identifier with each other, when a case selected from the group consisting of the second identifier being decrypted, the second identifier being confirmed as being the first electronic watermark embedded therein, and the second identifier being decrypted and being confirmed as being the first electronic watermark embedded therein is satisfied;
instructions configured to read content data from the data area;
instructions configured to conduct an operation selected from decrypting the content data, confirming if the content data is a second electronic watermark embedded therein, and decrypting the content data and confirming if the content data is the second watermark embedded therein when at least a predetermined part of the first and second identifiers are identical to each other; and
instructions configured to replay the content data when a case selected from the group consisting of the content data being confirmed as being the second electronic watermark embedded therein, the content data being decrypted, and the content data being decrypted and being confirmed as being the second electronic watermark embedded therein is satisfied.

11. A computer readable storage medium comprising:
an identifier area configured to store a first identifier; and
a data area configured to store:
a second identifier having at least one characteristic in which the second identifier is encrypted, the second identifier is a first electronic watermark embedded therein, and the second identifier is the first electronic watermark embedded therein and is encrypted;
content data having at least one characteristic in which the content data is encrypted, the content data is a second electronic watermark embedded therein, and the content data is the second electronic watermark embedded therein and is encrypted; and
a replay program configured to make a computer execute instructions comprising:
instructions configured to read the first identifier from the identifier area;
instructions configured to read the second identifier from the data area;
instructions configured to conduct an operation selected from the group consisting of decrypting the second identifier, confirming if the second identifier is the first electronic watermark embedded therein, and decrypting the second identifier and confirming if the second identifier is the first electronic watermark embedded therein;
instructions configured to compare the first identifier and the second identifier with each other when a case selected from the group consisting of the second identifier being decrypted, the second identifier being confirmed as being the first electronic watermark embedded therein, and the second identifier being decrypted and being confirmed as being the first electronic watermark embedded therein is satisfied;
instructions configured to read the content data from the data area;
instructions configured to conduct an operation selected from decrypting the content data, confirming if the content data is the second electronic watermark embedded therein, and decrypting the content data and confirming if the content data is the second watermark embedded therein when at least a predetermined part of the first and second identifiers are identical to each other; and
instructions configured to replay the content data when a case selected from the group consisting of the content data being decrypted, the content data being confirmed as being the second electronic watermark embedded therein, and the content data being decrypted and being confirmed as being the second electronic watermark embedded therein is satisfied.

12. A writing method comprising:
writing a second identifier in a data area, the second identifier being obtained by at least one operation in which a first identifier written in an identifier area is encrypted, a first electronic watermark is embedded in the first identifier, and the first electronic watermark in the first identifier is embedded and is encrypted;
writing content data to the data area, the content data having at least one characteristic in which the content data is encrypted, the content data is a second electronic watermark embedded therein, and the content data is the second electronic watermark embedded therein and is encrypted; and
writing a replay program to the data area, the replay program being configured to make a computer execute instructions comprising:
instructions configured to read the first identifier from the identifier area;
instructions configured to read the second identifier from the data area;
instructions configured to conduct an operation selected from the group consisting of decrypting the second identifier, confirming if the second identifier is the first electronic watermark embedded therein, and decrypting the second identifier and confirming if the second identifier is the first electronic watermark embedded therein;
instructions configured to compare the first identifier and the second identifier with each other when a case selected from the group consisting of the second identifier being decrypted, the second identifier being confirmed as being the first electronic watermark embedded therein, and the second identifier being decrypted and being confirmed as being the first electronic watermark embedded therein is satisfied;
instructions configured to read the content data from the data area;
instructions configured to conduct an operation selected from decrypting the content data, confirming if the content data is the second electronic watermark embedded therein, and decrypting the content data and confirming if the content data is the second watermark embedded therein, when at least a predetermined part of the first and second identifiers are identical to each other; and
instructions configured to replay the content data when a case selected from the group consisting of the content data being decrypted, the content data being confirmed as being the second electronic watermark embedded therein, and the content data being decrypted and being confirmed as being the second electronic watermark embedded therein is satisfied.

13. A writing apparatus comprising:
a slot configured to receive a storage device therein;
an identifier reader configured to read a first identifier from an identifier area of the storage device inserted in the slot;
an identifier processor configured to obtain a second identifier by conducting at least one operation in which a first electronic watermark in the first identifier is embedded, the first identifier is encrypted, and the first identifier being the first electronic watermark embedded therein is encrypted;
a storage unit configured to store:
content data having a characteristic selected from the group consisting of embedding a second electronic watermark therein, being encrypted, and embedding the second electronic watermark therein and being encrypted; and
a replay program configured to make a computer execute instructions comprising:
instructions configured to read the first identifier from the identifier area;
instructions configured to read the second identifier from a data area of the storage device;
instructions configured to conduct an operation selected from the group consisting of decrypting the second identifier, confirming if the second identifier is the first electronic watermark embedded therein, and decrypting the second identifier and confirming if the second identifier is the first electronic watermark embedded therein;
instructions configured to compare the first identifier and the second identifier with each other when a case selected from the group consisting of the second identifier being decrypted, the second identifier being confirmed as being the first electronic watermark embedded therein, and the second identifier being decrypted and being confirmed as being the first electronic embedded watermark embedded therein is satisfied;
instructions configured to read the content data from the data area;
instructions configured to conduct an operation selected from decrypting the content data, confirming if the content data is the second electronic watermark embedded therein, and decrypting the content data and confirming if the content data is the second watermark embedded therein when at leas a predetermined part of the first and second identifiers are identical to each other; and
instructions configured to replay the content data when a case selected from the group consisting of the content data being decrypted, the content data being confirmed as being the second electronic watermark embedded therein, and the content data being decrypted and being confirmed as being the second electronic watermark embedded therein is satisfied; and
a writer configured to write the second identifier, content data, and replay program to the data area of the storage device.

14. A storage device comprising:
the storage medium of claim 11; and
a storage medium support frame configured to hold the storage medium and provided with visible information that corresponds to a part of the identifiers, the visible information being visible from the outside and selected from the group consisting of a character, symbol, pattern, color, and combination of a character, symbol, pattern, and color.

15. The writing apparatus of claim 13, wherein:
the storage unit is configured to store a given part of the first identifier, visible information, the content data, the replay program, and a title of the content data that are related to one another;
the writing apparatus further comprises:
a display controller configured to read the visible information and title from the storage unit and output a display signal to display the visible information and title; and
a display configured to receive the display signal from the display controller and display the visible information and title; and
the writer writes the content data and replay program corresponding to the given part of the first identifier to the data area of the storage device.
